(19) United States
(12) Patent Application Publication
(10) Pub. No.: US 2008/0056727 A1
(43) Pub. Date: Mar. 6, 2008

(54) Optical transmitter and drive method of same

(75) Inventors: Masato Nishihara, Kawasaki (JP); Tomoo Takahara, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/785,760

(22) Filed: Apr. 19, 2007

(30) Foreign Application Priority Data
Sep. 5, 2006 (JP) 2006-240268

(51) Int. Cl. H04B 10/12; H04B 10/04

(52) U.S. Cl. 398/155; 398/185

(57) ABSTRACT

An optical transmitter for performing optical phase modulation according to a data signal and further applying optical intensity modulation in synchronization with clock signals and transmitting the optical signals, wherein in order to maintain the phase difference between the data signal and the clock signal constant with a simple configuration, the optical transmitter is configured so that clock signals are not individually supplied from the outside, but a clock component thereof is extracted from the data signal itself and a clock signal recovered based on the extracted clock component is defined as the clock signal. For this purpose, the configuration is made so that a clock recovery function unit is newly introduced.

### BACKGROUND OF THE INVENTION

1. Field of the Invention

The present invention relates to an optical transmitter, more particularly relates to an optical transmitter for applying phase modulation and intensity modulation to an optical signal and transmitting the result to a receiver, and a method of driving the optical transmitter.

2. Description of the Related Art

In recent years, demand has been rising for introduction of the next generation 40 Gbit/s (Gb/s) optical transmission system. In addition, a transmission distance and efficiency of frequency utilization equivalent to those of the conventional 10 Gb/s optical transmission system are being demanded. As means able to meet these demands, there has been active R&D into the RZ-DPSK (return to zero-differential phase shift keying) modulation scheme or CSRZ-DPSK (carrier suppressed-DPSK) modulation scheme better in optical signal-to-noise ratio (OSNR) tolerance and non-linear tolerance in comparison with the NRZ (non return to zero) modulation scheme applied to conventional 10 Gb/s or less optical transmission systems.

Further, there has been active R&D into phase modulation schemes such as the RZ-DQPSK (RZ-differential quadrature phase shift keying) modulation scheme featuring a high frequency utilization efficiency and narrow spectrum.

FIG. 14 is a table showing that the phase modulation scheme+intensity modulation scheme is superior to other modulation schemes. This shows that the “RZ-DPSK” modulation scheme and “RZ-DQPSK” modulation scheme on the right side in the table have excellent general features. The present invention employs these two schemes. In comparison with these two schemes, the table simultaneously shows the general features of modulation schemes of the conventionally known NRZ, Duo binary, and CS-RZ modulation schemes. These general features are the “optical noise tolerance”, “chromatic dispersion tolerance”, “PMD tolerance”, “optical non-linear tolerance”, “OADM filter passing tolerance”, and “configuration (size/cost)” described at the left end of the table. In particular, the RZ-DQPSK scheme on the right end of the table is outstandingly excellent in features in comparison with the other schemes, and therefore, attention is being paid to this scheme as the transmission method of the next generation optical transmission system. Below, an optical transmitter according to this RZ-DQPSK modulation scheme will be explained as a typical example, but the technical idea of the present invention is not limited to the case of this modulation scheme. The present invention can also be applied to optical transmitters using the RZ-DPSK modulation scheme, CSRZ-DQPSK modulation scheme combined with the CSRZ modulation scheme, and the CSRZ-DPSK modulation scheme (explained later).

FIG. 15 is a diagram showing a conventional example of an optical transmitter using the RZ-DQPSK modulation scheme. In the figure, an optical transmitter 1 according to the conventional example is configured by a transmission data processing unit 2, MUX unit (multiplex unit) 3, and driver unit 4 comprised of an electrical system and an optical modulation unit 5 comprised of an optical system. A 40 Gb/s, for example, data signal to be transmitted to the receiver is optically modulated at the optical modulation unit 5 while being synchronized with a 20 GHz clock signal CK and transmitted as an RZ-DQPSK output signal light OUT to a receiver RX.

The above-described transmission data processing unit 2 is configured by three function units for processing input data Din to be transmitted to the receiver. A first function unit is a framer for changing input data Din to an OTN (optical transport network) frame, a second function unit is an FEC (forward error correction) encoder for applying an error correction code to the input data Din, and a third function unit is a DQPSK precoder for performing encoding reflecting difference information between the present code and a one bit previous code.

The above-described function units involve complex data processing, therefore processing is difficult at a high 40 Gb/s bit rate. This is handled by parallel processing at 2.5 Gb/s low bit rates. Accordingly, the transmission data processing unit 2 outputs a 2.5 Gb/s×16 (=40 Gb/s) data signal. Note that this signal structure is determined by the SFI (SERDES framer interface) standard.

The parallel data signals from the 16 2.5 Gb/s signal lines in the above parallel processing are combined (multiplexed) at for example the 16:1 MUX (multiplexer) 11 forming the MUX unit 3. Accordingly, this 16:1 MUX 11 is also referred to as a “serializer”.

The 40 Gb/s data signal D obtained by combination by the 16:1 MUX 11 in this way is input to the driver unit 4. At this time, a 20 GHz clock signal CK corresponding to ½ rate of that data signal D is input to the driver unit 4.

This driver unit 4 inputs the 40 Gb/s data signal D described above to a 1:2 DEMUX (demultiplexer) 12 which demultiplexes it into two data signals each having 20 Gb/s while performing wave shaping. As the clock signal used for this processing, it uses a clock signal obtained by dividing the 20 GHz clock signal CK from the 16:1 MUX 11 explained above into two by a divider 13. Note that the other 20 GHz clock signal is given to the phase shifter 15.

The two 20 Gb/s data signals demultiplexed and wave shaped while synchronized with the above-described clock signal (20 GHz) in the 1:2 DEMUX 12 described above are amplified by a pair of amplifiers 14 and 14′ and then they are input as first drive signals to the optical modulation unit 5. The clock signal from the phase shifter 15 is also amplified by the amplifier 16, then input as a second drive signal to the optical modulation unit 5 in the same way. This phase shifter 15 minimizes the phase difference between the output from the modulator 18 and the input to the modulator 19 from the amplifier 16.

This optical modulation unit 5 is configured by a CW light source 17, a DQPSK modulator 18 serving as the optical phase modulation unit, and an RZ modulator 19 serving as the optical intensity modulation unit as illustrated. The continuous wave light from the CW light source 17 is input to the DQPSK modulator 18 where it is modulated by DQPSK optical modulation by the drive signals (data signals) from the amplifiers 14 and 14′. The DQPSK optical modulated signal is input to the RZ modulator 19 where it is further transformed into pulses at an RZ optical modulator according to the drive signal (clock signal) from the amplifier 16 to become RZ-DQPSK output signal light and is transmitted via an optical fiber to the receiver RX. Note that RZ (CSRZ) optical modulation uses the output signal light not as continuous wave light, but as an alternate signal (signal alternately switching between 0 and 1) light and therefore is useful for lowering the mean output light power.

As known art related to the above optical transmitter 1, there is the following Japanese Patent Publication (A) No. 2002-353896. This Japanese Patent Publication (A) No. 2002-353896 also describes an optical transmission apparatus provided with an optical phase modulator and an optical intensity modulator in the same way as the above.

The conventional optical transmitter 1 shown in FIG. 15 has two problems. These are the following problem 1 and problem 2. The problem 1 is that it is difficult to constantly keep the phase difference between the 40 Gb/s data signal D and the 20 GHz clock signal CK in FIG. 15 despite temperature fluctuations etc. (see “ΔDd-ck” in the figure, where d represents D, and ck represents CK) at a constant value or less. This invites deterioration of the transmission characteristic.

The problem 2 is that it is necessary to control the phase difference between the output signal from the DQPSK modulator 18 and the drive signal (clock signal) to the RZ modulator 19 in FIG. 17 explained later (figure showing only the related portion in FIG. 15), that is “ΔDdqp-rz” (dqp represents DQPSK, and rz represents RZ), to a constant value or less despite temperature fluctuations and aging.

Explaining the above problem 1 in further detail, as explained before, the driver unit 4 of FIG. 15 receives as input both the 40 Gb/s data signal D and the 20 GHz clock signal CK from the 16:1 MUX 11. In such a configuration, when a phase difference due to a deviation between the two signals occurs in the phase difference between the data signal D and the clock signal CK, decision error of data occurs in the 1:2 DEMUX 12 when demultiplexing and wave shaping the data signal D. This causes degradation of the transmission characteristics.

According to the prior art, it is confirmed that the phase difference between the data signal D and the clock signal CK input to the driver unit 4 changes by about 1 ps/10° C. due to the temperature characteristic of the circuits etc. configuring the 16:1 MUX 11. An explanation will be given here with reference to FIG. 16.

FIGS. 16A and 16B are diagrams showing the bit rate dependencies of the data decision phase (eye pattern) margin for the case of a low bit rate (A) and the case of a high bit rate (B). According to the prior art, as explained above, the above phase difference changes by about 1 ps/10° C. due to the temperature characteristics, but in the case of a conventional optical transmission system of a low bit rate such as 10 Gb/s, 1 time slot of the data signal D is about “100 ps”, therefore the influence of the change of 1 ps/10° C. explained above due to the temperature fluctuation upon the above-described phase difference is sufficiently small and can be ignored (see FIG. 16A).

However, in a high 40 Gb/s bit rate optical transmission system covered by the present invention, 1 time slot of the data signal D becomes a small “25 ps” or less, so the influence upon the phase difference due to temperature fluctuation is no longer negligible (see FIG. 16B).

In the final analysis, in a high 40 Gb/s bit rate optical transmission system, the phase difference between the data signal D and the clock signal CK must be always held at a constant value or less without regard as to temperature fluctuations etc. To hold this, it can be considered to employ for example feedback control, but in practice, there is the problem that it is actually difficult to accomplish such feedback control with a high precision under a high bit rate.

The above problem 2 will be explained in more detail below with reference to FIG. 17. FIG. 17 is a diagram showing only a portion of FIG. 15 taken out for explaining the problem 2 of the present invention.

Referring to FIG. 17, in the RZ-DQPSK modulation scheme, the DQPSK modulator 18 and the RZ modulator 19 are cascade connected, the continuous wave light from the CW light source 17 is phase modulated according to the data signal D and further intensity modulated according to the clock signal CK to generate an output signal light, and the thus generated output signal light is transmitted to the receiver.

In this case, the phase difference between the optical signal from the modulator 18 input to the RZ modulator 19 and the clock signal from the amplifier 16 for driving the RZ modulator 19, that is, “ΔDdqp-rz”, exerts an influence upon the transmission characteristic of the optical transmitter 1. This “ΔDdqp-rz” is the phase difference generated due to a difference between a delay ΔDdqp·ck of the clock of the DQPSK (data) side and a delay ΔDrz·ck of the clock of the RZ (clock) side. In more detail, this ΔDdqp·ck is the phase difference generated due to the difference between ΔDdqp·ck+ΔDd+ΔDln+fb and ΔDrz·ck. Note that, the ln in ΔDln+fb represents LiNbO₃ as the composition of the modulator 18, and fb represents an optical fiber FB connecting the modulator 18 and the modulator 19. That is, ΔDdqp-rz=(ΔDdqp·ck+ΔDd+ΔDln+fb)−ΔDrz·ck. This ΔDdqp-rz is closely related with the so-called Q (quality) value penalty. This will be represented by a graph.

FIG. 18 is a graph showing a relationship between the above-described ΔDdqp-rz and the Q value penalty. The phase difference ΔDdqp-rz(ps) is plotted on its abscissa, and the Q value penalty (dB) is plotted on its ordinate. Referring to the present graph, when the absolute value of the phase difference ΔDdqp-rz becomes large, the Q value penalty increases. Accordingly, in order to constantly maintain the Q value penalty at a certain threshold or less, it is necessary to hold the ΔDdqp-rz at a certain constant value or less. According to the example of the present graph, when the threshold is set at 0.2, ΔDdqp-rz must be held at 12 (=6+6) ps or less.

On the other hand, the signal delay on the circuit also changes due to temperature fluctuations and the aging of the circuit (1). Accordingly, the above-described ΔDdqp-rz also changes. For this reason, a means for controlling the ΔDdqp-rz to be held at a constant value or less even when the circuit changes in state due to temperature fluctuations or aging becomes necessary.

According to the conventional example, that means is configured so as to monitor the temperature of the above-described circuit and adjust the amount of phase shift of the phase shifter 15 for shifting the phase of the clock signal in accordance with the monitored temperature of the circuit and controls the ΔDdqp-rz so that for example it is always 12 ps or less in FIG. 18.

Then, for this purpose, a feed forward configuration of previously actually measuring the amount of phase shift of the phase shifter 15 which was the optimum for each temperature and preparing and holding a correspondence table of temperature vs phase shift was necessary.

However, it is considerably difficult to prepare the above-described correspondence table considering also the aging of the circuit described above and the variation of elements configuring the circuit. In the end, there is the problem that a high precision control of the above-described ΔDdqp-rz over a long period is not easy.

### SUMMARY OF THE INVENTION

Accordingly, in consideration of the above-described problems, an object of the present invention is to provide an optical transmitter able to always optimally maintain the phase difference between the data signal and the clock signal (i) without employing a feed forward configuration detecting the phase difference between the data signal and the clock signal and constantly minimizing this and (ii) without considering temperature fluctuations and aging of the circuit. Further, another object is to provide a drive method of the same.

To attain the above objects, an optical transmitter according to the present invention does not individually supply clock signals CK from external portions, but extracts the clock component from the data signal D itself and uses a clock signal recovered based that extracted clock component as the above-described clock signal CK. For this purpose, a clock recovery function unit (21) is newly introduced.

### BRIEF DESCRIPTION OF THE DRAWINGS

The above objects and features of the present invention will be more apparent from the following description of the preferred embodiments given with reference to the accompanying drawings, wherein:

FIG. 1 is a diagram showing the basic configuration of an optical transmitter according to the present invention;

FIG. 2 is a diagram showing a drive method in the configuration shown in FIG. 1;

FIG. 3 is a diagram showing an optical transmitter according to a first embodiment of the present invention;

FIG. 4 is a diagram showing an optical transmitter according to a second embodiment of the present invention;

FIG. 5 is a diagram showing a concrete example of a 1:2 DEMUX forming a wave shaping unit of FIG. 3;

FIG. 6 is a diagram showing an optical transmitter according to a third embodiment of the present invention;

FIG. 7 is a diagram showing an optical transmitter according to a fourth embodiment of the present invention;

FIG. 8 is a first diagram showing a concrete example of a PLL portion 42 in FIG. 3 and FIG. 6;

FIG. 9 is a second diagram showing a concrete example of the PLL portion 42 in FIG. 3 and FIG. 6;

FIG. 10 is a diagram showing a concrete example of a PLL portion 42′ in FIG. 4 and FIG. 7;

FIG. 11 is a diagram showing an example of the configuration of a DQPSK modulator 18;

FIG. 12 is a diagram for explaining an extinction voltage;

FIG. 13 is a diagram showing an example of the configuration of a divider;

FIG. 14 is a table showing that phase modulation+intensity modulation is superior to other modulation schemes;

FIG. 15 is a diagram showing a conventional example of an optical transmitter using an RZ-DQPSK modulation scheme;

FIGS. 16A and 16B are diagrams showing data decision phase margins for a low bit rate (A) and a high bit rate (B);

FIG. 17 is a diagram showing an extracted portion of FIG. 15 for explaining one of the problems of the present invention; and

FIG. 18 is a graph showing a relationship between ΔDdqp-rz and Q value penalty.

### DESCRIPTION OF THE PREFERRED EMBODIMENTS

Preferred embodiments of the present invention will be described in detail below while referring to the attached figures.

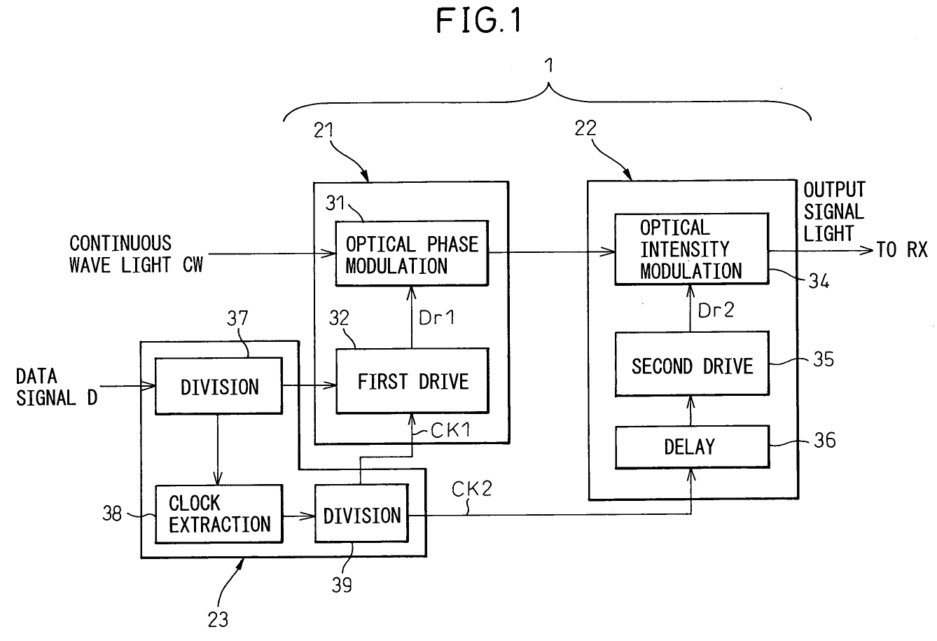

FIG. 1 is a diagram showing the basic configuration of an optical transmitter according to the present invention. In the figure, the optical transmitter 1 is configured by a phase modulation function unit 21, an intensity modulation function unit 22, and a clock recovery function unit 23.

The phase modulation function unit 21 receives as input the data signal D to be transmitted to a receiver RX and modulates the phase of continuous wave light CW by a first drive signal Dr1 generated by a first driving means 32 in synchronization with a first clock signal CK1 using an optical phase modulating means 31.

The intensity modulation function unit 22 further modulates the intensity of the phase modulated signal by a second drive signal Dr2 generated by a second driving means 35 in synchronization with a second clock signal CK2 by using an optical intensity modulating means 34 and transmits the same to the receiver RX. Preferably, the second clock signal CK2 is delayed by a delaying means 36.

The clock recovery function unit 23 divides the data signal D to be input to the phase modulation function unit 21 by a dividing means 37 at a stage in front of that input and generates the first clock signal CK1 and second clock signal CK2 from the clock component extracted from the divided data signals by a clock extracting means 38 via a dividing means 39.

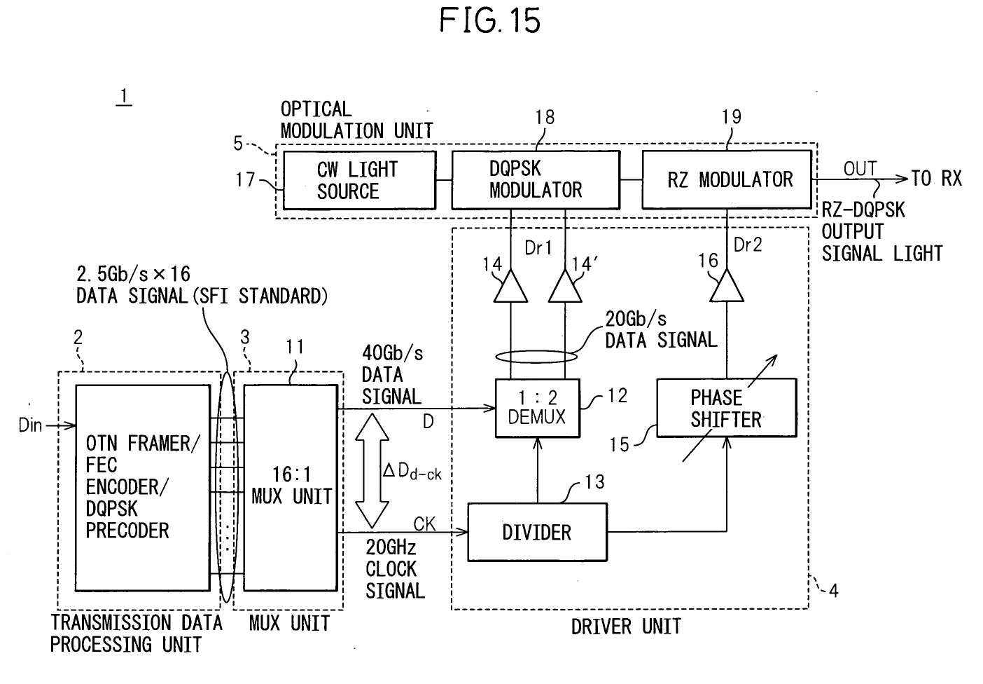

Thus, according to the optical transmitter 1 of the present invention, (i) the first clock signal CK1 to be input to the first driving means 32 including for example a 1:2 DEMUX 12 (FIG. 15) is created by extraction from the data signal D itself by the clock recovery function unit 23. Also, the second clock signal CK2 to be input to the optical intensity modulation function unit 22 is created by extraction from the data signal D itself in the same way as the above.

Accordingly, even when temperature fluctuation and aging occur in the circuits etc. configuring the optical transmitter 1 and the phase of the data signal D is deviated, exactly the same phase deviation simultaneously occurs also in the clock signals (CK1, CK2) created from the data signal. That is, the phase characteristic of the data signal and the phase characteristic of the clock signal are always synchronized.

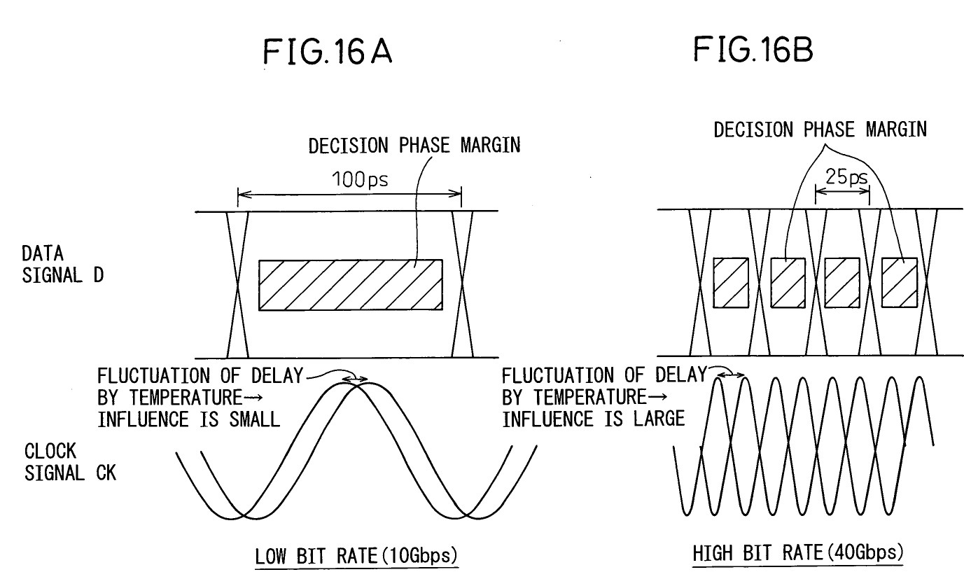

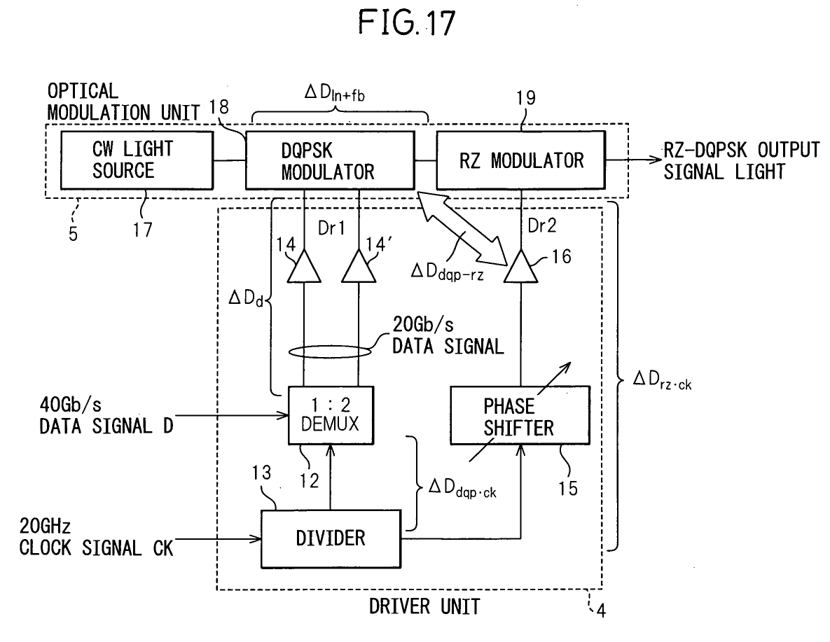

For this reason, the clock signal CK1 in the 1:2 DEMUX 12 described above will never deviate from the data discrimination phase margin (see FIG. 16B), and no penalty will occur in the transmission characteristic of the output signal light OUT.

Further, conventionally, it is necessary to lay a clock transmission line for transmitting a 20 GHz high speed clock signal on the board between the MUX unit 3 and the driver unit 4 shown in FIG. 15. This had become one of the restrictions in circuit design. According to the present invention, there is also the advantage that such a clock transmission line becomes absolutely unnecessary, so an increase in the degree of freedom of circuit design is obtained. This concludes the description related to the already explained problem 1.

(ii) The delaying means 36 is provided so that the phase difference between the second drive signal (clock) Dr2 input to the optical intensity modulating means 34 shown in FIG. 1 and the first drive signal (data) Dr1 input to the optical phase modulating means 31 coincides. Accordingly, the phase difference “ΔDdqp-rz” shown in FIG. 17 is maintained at the minimum irrespective of temperature fluctuations and aging. Note that the aforesaid delay “ΔDln+fb” (delay by the modulator 18 and the optical fiber FB) shown in FIG. 17 remains.

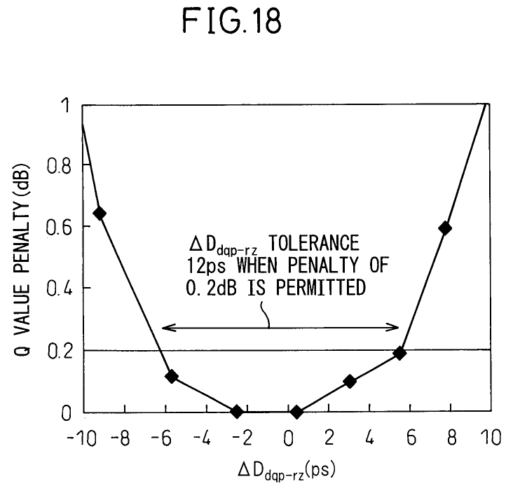

However, that delay “ΔDln+fb” is a small one of about 3 ps p-p. In the graph of FIG. 18, the Q value penalty occurring due to the above-described “ΔDdqp-rz” becomes extremely small, i.e., 0.05 dB or less. However, in the future, when the system can be configured so that the phase modulator (18) and the intensity modulator (19) are integrated and they can be accommodated on one chip, the above-described ΔDln-fb will become further smaller and accordingly also the above-described ΔDdqp-rz will inevitably become smaller. The above description related to the already explained problem 2.

Thus, according to the present invention, the transmission characteristic of the optical transmitter 1 can be maintained in an initial optimal state free from maintenance for a long period without having to consider temperature fluctuations and aging much at all.

Here, considering the idea of “extraction of the clock signal from the data signal” proposed in the present invention, such extraction is generally carried out on the receiver RX of the optical transmission system. That is, the clock signal is extracted from the received data signal, then the original data is recovered by using this extracted clock signal.

However, the present invention is an optical transmitter configured so that the clock signal is extracted from the original data signal to be transmitted to the receiver RX and so that the data signal for transmission to the receiver RX is generated by using this extracted clock signal. No optical transmitter provided with such a configuration has yet been known.

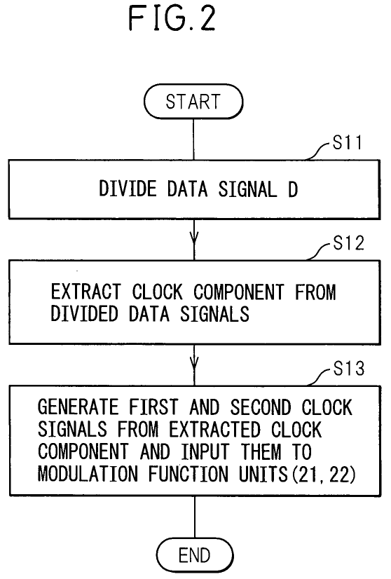

FIG. 2 is a flow chart for explaining the drive method in the configuration shown in FIG. 1. This drive method is a method of driving an optical transmitter 1 having a phase modulation function unit 21 receiving as input the data signal D to be transmitted to the receiver RX and modulating the phase of continuous wave light CW by a first drive signal Dr1 generated in synchronization with the first clock signal CK1 and an intensity modulation function unit 22 further applying intensity modulation to the phase modulated signal by a second drive signal Dr2 generated in synchronization with the second clock signal CK2 and comprises steps S11, S12, and S13.

Step S11: The data signal to be input to the phase modulation function unit 21 is divided at a stage in front of the input.

Step S12: The clock component is extracted from the data signal D divided according to step S11.

Step S13: The first clock signal CK1 and second clock signal CK2 are generated from the component extracted according to step S12 and input to the phase modulation function unit 21 and intensity modulation function unit 22.

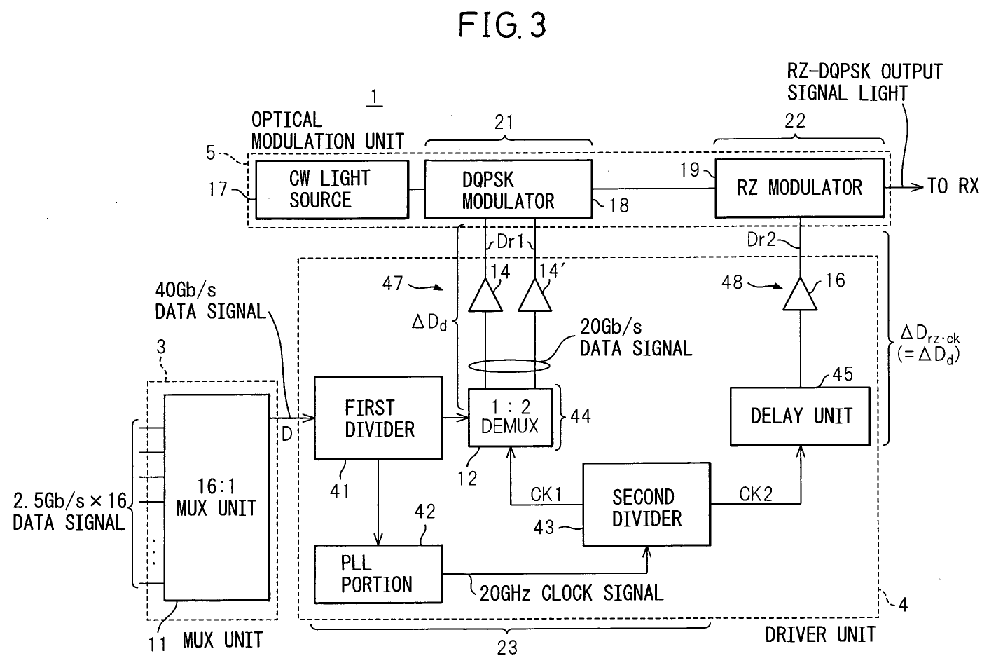

Next, several embodiments of the optical transmitter 1 driven according to the above-described drive method will be explained. FIG. 3 is a diagram showing an optical transmitter 1 according to a first embodiment of the present invention. Note that the same reference numerals or symbols will be attached to the same components throughout all of the drawings.

Most of the configuration of FIG. 3 is the same as the conventional configuration shown in FIG. 15. The components newly introduced in the first embodiment are a first divider 41 (corresponding to 37 of FIG. 1), a PLL (phase locked loop) portion 42 (corresponding to 38 of FIG. 1), and a second divider 43 (corresponding to 39 of FIG. 1). This second divider 43 is equivalent to the divider 13 of FIG. 15. These components configure the clock recovery function unit 23 of FIG. 1. Further, on the optical intensity modulation function unit 22 side, a delay unit 45 (corresponding to 36 of FIG. 1) is introduced. Note that reference numeral 47 is a first amplification unit, and reference numeral 38 is a second amplification unit. These are configured by a pair of amplifiers 14 and 14′ and an amplifier 16 in the same way as FIG. 15.

Thus, in the above-described first embodiment employing the DQPSK modulation scheme for the phase modulation and employing the RZ modulation scheme for the intensity modulation, the clock recovery function unit 23 includes a first divider 41 for outputting divided data signals as explained above, a PLL portion 42 for extracting the clock component from these divided data signals, and a second divider 43 for dividing this extracted clock signal into the first clock signal CK1 and the second clock signal CK2.

Further, the phase modulation function unit 21 of the first embodiment has a wave shaping unit 44 for performing the wave shaping with respect to the data signal D in synchronization with the first clock signal CK1 and a first amplification unit 47 for amplifying the wave shaped signal and outputting a first drive signal Dr1.

Further, the intensity modulation function unit 22 of the first embodiment has a delay unit 45 for giving a constant delay to the second clock signal CK2 and a second amplification unit 48 for amplifying that delay signal and outputting a second drive signal Dr2. The delay is set equal to a transmission delay from the input of the data signal D to the generation of the first drive signal Dr1 in the phase modulation function unit 21. Namely, ΔDrz·ck on the right side in FIG. 3 is made equal to the delay ΔDd on the left side thereof. This is for making the difference of transmission delays on the lines of the first drive signal Dr1 and the second drive signal Dr2 almost zero.

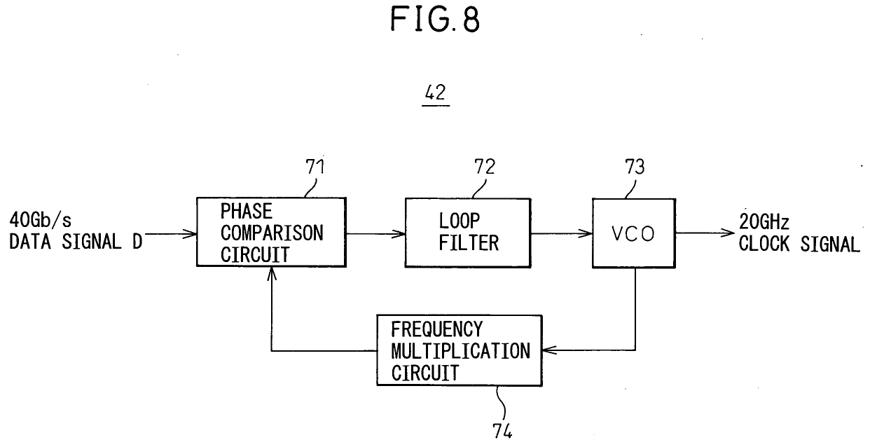

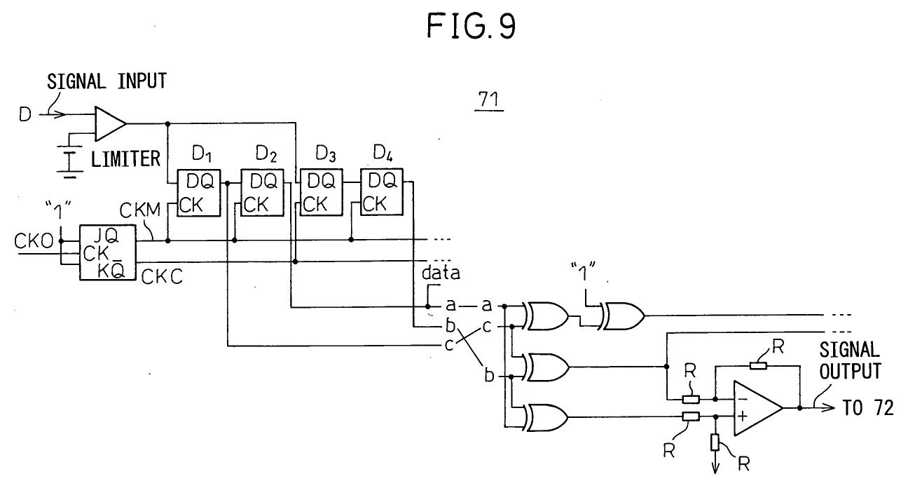

The first embodiment for DQPSK modulation is more specifically configured as follows. First, the PLL portion 42 in the clock recovery function unit 23 is configured so as to extract a clock component of ½ the rate of that of the data signal D explained before. The wave shaping unit 44 in the phase modulation function unit 21 includes a 1:2 demultiplexer 12 for demultiplexing the data signal D to two, i.e., a pair of data signals (20 Gb/s data signals), in synchronization with the first clock signal CK1 comprised of the clock component of that ½ rate. At the same time, the first amplification unit 47 is configured by a pair of amplifiers 14 and 14′ for amplifying that pair of data signals and outputting a pair of first drive signals Dr1. Note that a detailed example of the above-described PLL portion 42 will be shown later (see FIG. 8 and FIG. 9).

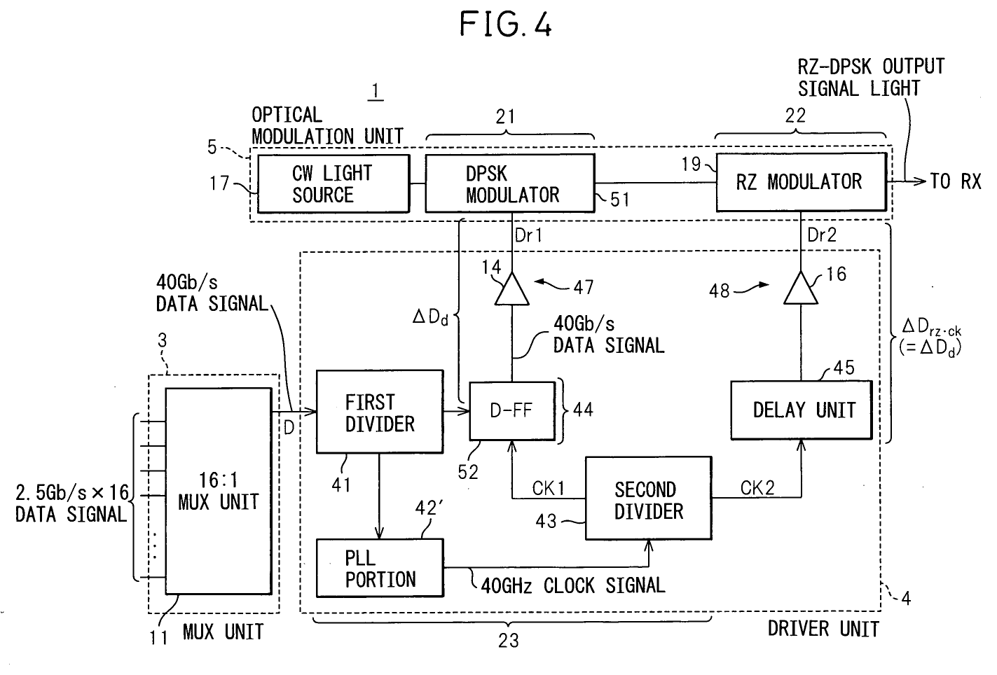

FIG. 4 is a diagram showing an optical transmitter 1 according to a second embodiment of the present invention. In this second embodiment, the DQPSK modulator 18 in the first embodiment is replaced by a DPSK modulator 51. Since it therefore uses the DPSK modulation scheme, the wave shaping unit 44 and the first amplification unit 47 are different from the case of the first embodiment, and the PLL portion 42 in the first embodiment is changed to the PLL portion 42′.

Namely, the PLL portion 42′ in the clock recovery function unit 23 is configured so as to extract the clock component of the same rate as that of the data signal D explained before. The phase modulation function unit 21 configures the wave shaping unit 44 by an FF portion (D-FF) 52 for generating a signal obtained by wave shaping the data signal D in synchronization with the first clock signal CK1 comprised of the clock component having the same rate and, at the same time, includes an amplifier 14 for amplifying that wave shaped signal and outputting the first drive signal Dr1.

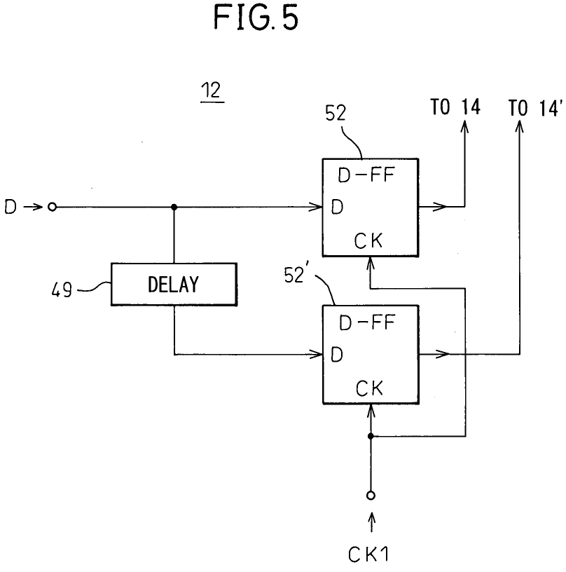

Here, in comparison with the wave shaping unit 44 configured by the above-described FF portion (D-FF) 52, the configuration of the 1:2 DEMUX (demultiplexer) 12 of the wave shaping unit 44 in the first embodiment (FIG. 3) will be shown in FIG. 5. In FIG. 5, the 1:2 DEMUX (demultiplexer) 12 forming the wave shaping unit 44 is configured by two FF portions (D-FF) 52, the data signal D is input as it is to one of these, and a data signal D delayed in phase by exactly π through the delay unit 49 is input to the other of these. By driving each FF portion by the clock signal having the ½ rate of the data signal D, the data signal D is divided into two. Then, wave shaped outputs from the FF portions (D-FF) 52 and 52′ are input to the pair of amplifiers 14 and 14′.

In the first and second embodiments explained above, when looking at the optical intensity modulating means (34) of each, both embodiments use RZ modulators 19 using the RZ modulation scheme. When employing such an RZ modulator 19, the intensity modulation function unit 22 of FIG. 3 (first embodiment) is configured by a delay unit 45 for applying a constant delay to the second clock signal CK2 comprised of the clock component having the ½ rate of that of the data signal D from the PLL portion 42 and by a second amplification unit 48 for amplifying the delay signal and outputting the second drive signal Dr2. That delay is set equal to the transmission delay when the data signal D passes through the 1:2 demultiplexer 12 and a pair of amplifiers 14 and 14′ (see ΔDrz·ck=ΔDd in the figure).

In the same way, when employing the RZ modulator 19, the intensity modulation function unit 22 of FIG. 4 (second embodiment) is configured by a delay unit 45 for giving a constant delay to the second clock signal CK2 comprised of the clock component having the same rate as that of the data signal D from the PLL portion 42′ and by a second amplification unit 48 for amplifying the delay signal and outputting the second drive signal Dr2. That delay is set equal to the transmission delay when the data signal D passes through the FF portion (D-FF) 52 and the amplifier 14 (see ΔDrz·ck=ΔDd in FIG. 4).

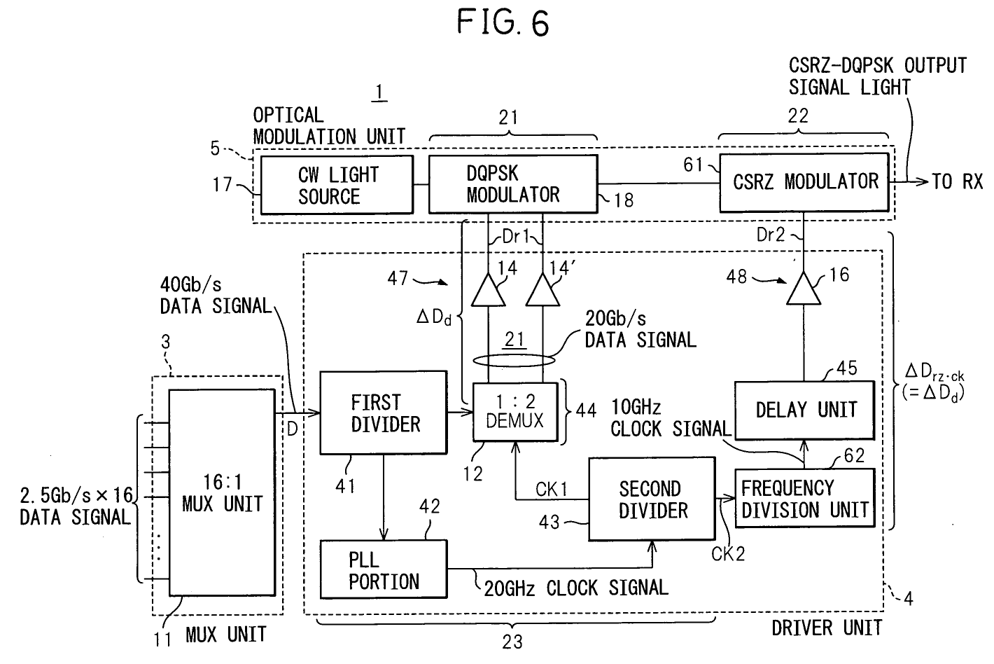

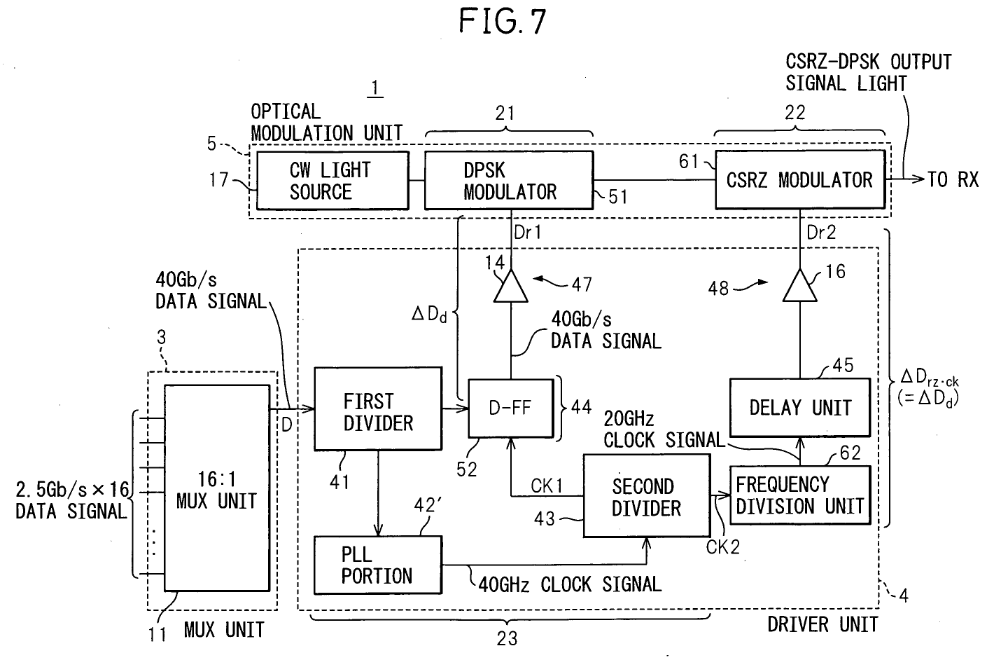

In the first and second embodiments (FIG. 3, FIG. 4) explained above, the RZ modulator 19 was employed as the optical intensity modulating means (34). However, the present invention is not limited to this. Another optical intensity modulation scheme can be used too. For example, the CSRZ modulation scheme can be used. Two embodiments according to the CSRZ will be shown in FIG. 6 and FIG. 7.

FIG. 6 shows a third embodiment of the optical transmitter according to the present invention which is combined with the DQPSK modulation scheme. Further, FIG. 7 shows a fourth embodiment according to the present invention which is combined with the DPSK modulation scheme.

Referring to FIG. 6 (third embodiment) first, most of the configuration is the same as the first embodiment of FIG. 3, but in the third embodiment using a CSRZ modulator 61, a frequency division unit 62 is introduced into the optical intensity modulation function unit 22.

The RZ modulator 19 using the RZ modulation scheme 1 explained before (FIG. 3, FIG. 4) uses a second drive signal Dr2 comprised of a signal having the same frequency as the bit rate of the data signal D and having a voltage amplitude of one time the extinction voltage. Contrary to this, the CSRZ modulator 61 using the CSRZ modulation scheme in the third and fourth embodiments (FIG. 6, FIG. 7) uses a second drive signal Dr2 comprised of a signal having a frequency of ½ of the bit rate of the data signal D and having a voltage amplitude of two times the extinction voltage.

Referring to the fourth embodiment of FIG. 7, the fourth embodiment is obtained by replacing the optical intensity modulation function unit 22 in the second embodiment shown in FIG. 4 by the optical intensity modulation function unit 22 shown in FIG. 6 (third embodiment) explained above.

In short, in the fourth embodiment in which the intensity modulation is carried out by the CSRZ modulation scheme, the intensity modulation function unit 22 is configured by a frequency division unit 62 for performing ½ frequency division of the second clock signal CK2 comprised of the clock component having the same rate as that of the data signal D from the PLL portion 42′, a delay unit 45 for giving a constant delay to the ½ frequency divided signal thereof, and a second amplification unit 48 for amplifying the delay signal and outputting the second drive signal Dr2. That delay is set equal to the transmission delay when the data signal D passes through the FF portion 52 and the amplifier 14. Further, the second amplification unit 48 outputs a voltage two times the extinction voltage of the intensity modulation.

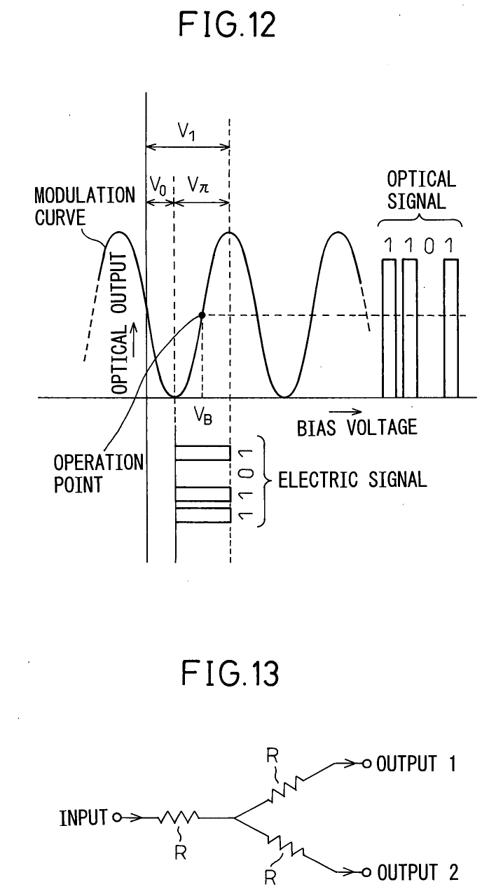

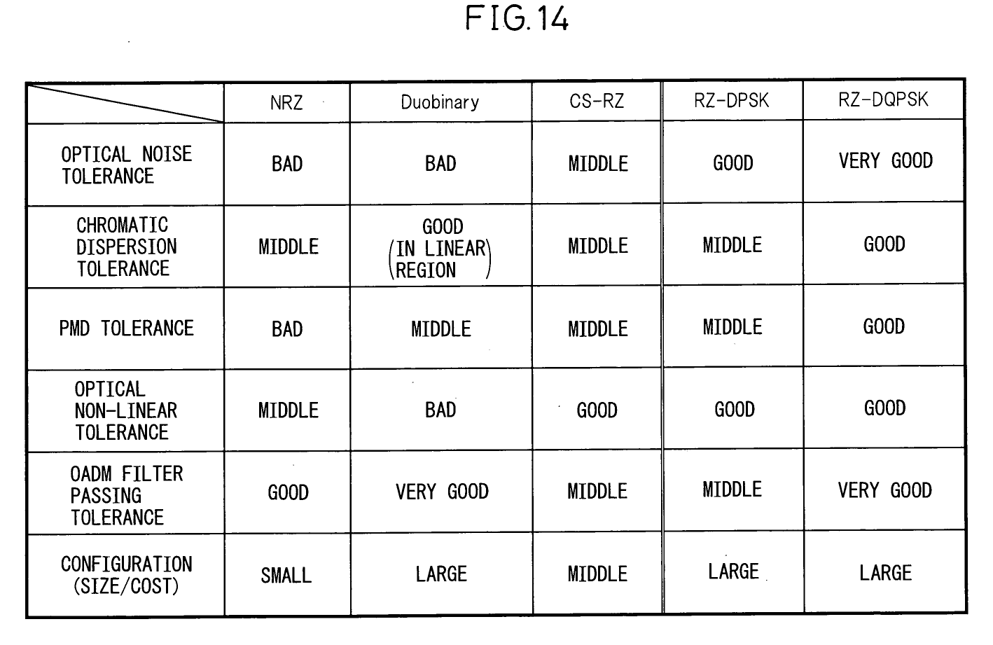

For this reason, in the third embodiment of FIG. 6, in order to generate the above-described “½ frequency”, the aforesaid frequency division unit (½ frequency division) 62 is introduced, and the second clock signal CK2 of 20 GHz is ½ multiplied to 10 GHz. Note that, an explanation will be given of the extinction voltage with reference to FIG. 12.

In short, in the third embodiment in which the intensity modulation is carried out using the CSRZ modulation scheme, the intensity modulation function unit 22 is configured by a frequency division unit 62 for performing ½ frequency division of the second clock signal CK2 comprised of the clock component having a rate of ½ of that of the data signal D from the PLL portion 42, a delay unit 45 for giving a constant delay to the ½ frequency divided signal thereof, and a second amplification unit 48 for amplifying the delay signal and outputting the second drive signal Dr2. That delay is set equal to the transmission delay when the data signal D passes through the 1:2 demultiplexer 12 and a pair of amplifiers 14 and 14′. Further, the second amplification unit 48 outputs a voltage two times the extinction voltage of the intensity modulation.

FIG. 8 is a first diagram showing a concrete example of the PLL portion 42 in FIG. 3 and FIG. 4, and FIG. 9 is a second diagram of same. Further, FIG. 10 is a diagram showing a concrete example of the PLL portion 42′ shown in FIG. 4 and FIG. 7.

Referring to FIG. 8 first, the PLL portion 42 receives as input the 40 Gb/s data signal D on the left in the figure and outputs the 20 GHz clock signal having the ½ rate thereof. The output of a VCO 73 is multiplied to two times the frequency at a frequency multiplication circuit 74 on the other hand and returned to a phase comparison circuit 71 where it is compared with the data signal D.

The phase difference of the result of that comparison is input to the VCO 73 through a loop filter 72. The VCO 73 performs a feedback operation so that the phase difference becomes zero. Accordingly, in a stable state, a VCO output completely phase synchronized with the data signal D is obtained.

Referring to FIG. 9, a known detailed example of the configuration of the phase comparison circuit 71 of FIG. 8 is shown.

The PLL portion 42′ shown in FIG. 10 outputs the 40 GHz phase clock signal synchronized with the 40 Gb/s data signal D in the same way, therefore the frequency multiplication circuit 74 of FIG. 8 is unnecessary. The frequency of the branch output of the VCO 73 is multiplied by 1 (passed through) and returned to the phase comparison circuit 71.

Finally, looking at the optical modulation unit 5, the DQPSK modulator 18 in that, the RZ modulator 19, and the already explained extinction voltage of the CSRZ modulator 61 will be supplementarily explained.

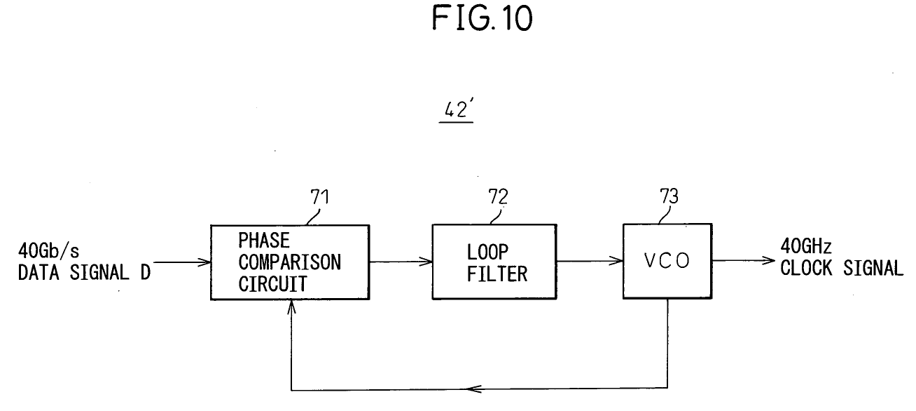

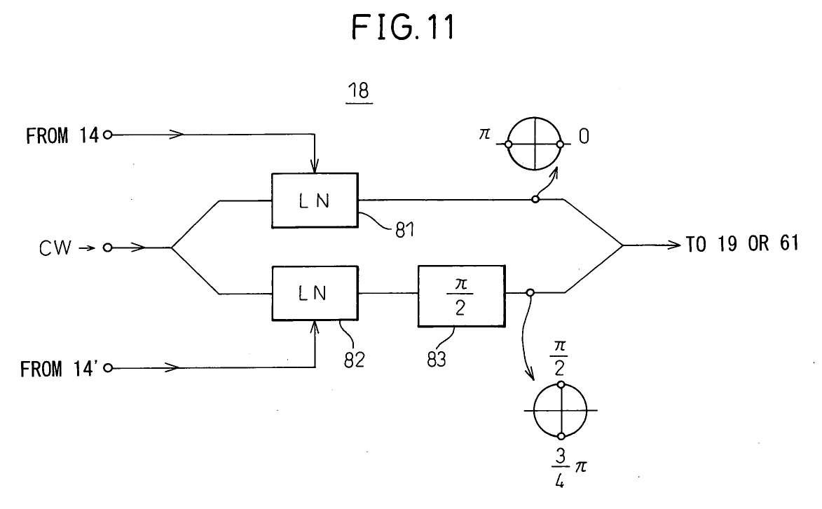

FIG. 11 is a diagram showing an example of the configuration of the DQPSK modulator 18. The input continuous wave light CW is divided into two by a pair of optical waveguides and modulated according to the data signal D in the LN optical modulators 81 and 82. These modulators 81 and 82 receive as input 20 Gb/s data signals D from the aforesaid pair of amplifiers 14 and 14′.

A π/2 shifter 83 is inserted at one LN optical modulator 82 side, therefore the data 1-0 on the LN optical modulator 81 side takes 0-π on the phase coordinates axis, but in contrast, on the LN optical modulator 82 side, the data 1-0 takes ½×π−¾π. These are combined and input to the optical intensity modulator 19 or 61 in the next stage.

FIG. 12 is a diagram for explaining the extinction voltage. As shown in the figure, a modulation curve of the LN modulator becomes a curve having a function of cos square. Here, the already explained extinction voltage is a voltage indicated by Vπ in the figure and corresponding to half cycle of the modulation curve thereof.

Further, FIG. 13 is a diagram showing an example of the configuration of the divider. The divider can be realized in various ways, but the most general configuration is a 2-divider using a resistor (R) shown in the figure.

As explained above, according to the present invention, irrespective of the extremely simple configuration, the phase difference between the data signal and the clock signal can be kept constant for a long period without concern over temperature fluctuations and aging and it becomes possible to maintain a good transmission characteristic while free from maintenance.

While the invention has been described with reference to specific embodiments chosen for purpose of illustration, it should be apparent that numerous modifications could be made thereto by those skilled in the art without departing from the basic concept and scope of the invention.

What is claimed is:

1. An optical transmitter comprised of:
a phase modulation function unit receiving as input a data signal to be transmitted to a receiver and modulating the phase of continuous wave light by a first drive signal generated in synchronization with a first clock signal;
an intensity modulation function unit further applying intensity modulation to said phase modulated signal by a second drive signal generated in synchronization with a second clock signal; and
a clock recovery function unit dividing said data signal to be input to said phase modulation function unit at a stage in front of its input and generating said first clock signal and second clock signal from the clock component extracted from the divided data signals.

2. An optical transmitter as set forth in claim 1, wherein said clock recovery function unit includes a first divider outputting said divided data signals, a PLL portion extracting said clock component from the divided data signals, and a second divider dividing the extracted clock signal into said first clock signal and second clock signal.

3. An optical transmitter as set forth in claim 1, wherein said phase modulation function unit has a wave shaping unit shaping the wave of said data signal in synchronization with said first clock signal and a first amplification unit amplifying the wave shaped signal and outputting said first drive signal.

4. An optical transmitter as set forth in claim 1, wherein said intensity modulation function unit has a delay unit giving a constant delay to said second clock signal and a second amplification unit amplifying that delay signal and outputting said second drive signal, and the delay is set equal to a transmission delay from the input of said data signal to generation of said first drive signal in said phase modulation function unit.

5. An optical transmitter as set forth in claim 1, wherein said phase modulation is carried out using a DQPSK modulation scheme.

6. An optical transmitter as set forth in claim 1, wherein said phase modulation is carried out using a DPSK modulation scheme.

7. An optical transmitter as set forth in claim 1, wherein said phase modulation is carried out using an RZ modulation scheme.

8. An optical transmitter as set forth in claim 1, wherein said phase modulation is carried out using a CSRZ modulation scheme.

9. An optical transmitter as set forth in claim 2, wherein said clock recovery function unit includes a PLL portion extracting said clock component from said divided data signals, said phase modulation function unit includes a wave shaping unit shaping the wave of said data signals, and a first amplification unit amplifying the wave shaped signals and outputting said first drive signals, and, when said phase modulation is carried out using the DQPSK modulation scheme,
said PLL portion in said clock recovery function unit is configured so as to extract a clock component having a ½ rate of that of said data signal, said wave shaping unit in said phase modulation function unit includes a 1:2 demultiplexer for demultixing said data signal into a pair of data signals in synchronization with said first clock signal comprised of the clock component of that ½ rate, and the first amplification unit is configured by a pair of amplifiers for amplifying that pair of data signals and outputting a pair of said first drive signals.

10. An optical transmitter as set forth in claim 2, wherein said clock recovery function unit includes a PLL portion extracting said clock component from said divided data signals, said phase modulation function unit includes a wave shaping unit for shaping the wave of said data signals, and, when said phase modulation is carried out using the DPSK modulation scheme,
said PLL portion in said clock recovery function unit is configured so as to extract the clock component of the same rate as that of said data signal, and said phase modulation function unit configures said wave shaping unit by an FF portion generating a signal obtained by wave shaping said data signal in synchronization with said first clock signal comprised of the clock component having the same rate and includes an amplifier amplifying that wave shaped signal and outputting said first drive signal.

11. An optical transmitter as set forth in claim 9, wherein when said intensity modulation is carried out using the RZ modulation scheme, said intensity modulation function unit is configured by a delay unit giving a constant delay to said second clock signal comprised of the clock component having the ½ rate of that of said data signal from said PLL portion and a second amplification unit amplifying delay signal and outputting said second drive signal, and the delay is set equal to the transmission delay when said data signal passes through said 1:2 demultiplexer and said pair of amplifiers.

12. An optical transmitter as set forth in claim 9, wherein when said intensity modulation is carried out using the CSRZ modulation scheme, said intensity modulation function unit is configured by a frequency division unit performing the ½ frequency division of said second clock signal comprised of the clock component having a rate of ½ of that of said data signal from said PLL portion, a delay unit giving a constant delay to the ½ frequency divided signal, and a second amplification unit amplifying the delay signal and outputting said second drive signal, the delay is set equal to the transmission delay when said data signal passes through said 1:2 demultiplexer and said pair of amplifiers, and said second amplification unit outputs a voltage two times an extinction voltage of said intensity modulation.

13. An optical transmitter as set forth in claim 10, wherein when said intensity modulation is carried out using the RZ modulation scheme, said intensity modulation function unit is configured by a delay unit giving a constant delay to said second clock signal comprised of the clock component having the same rate as that of said data signal from said PLL portion and a second amplification unit amplifying the delay signal and outputting said second drive signal, and the delay is set equal to the transmission delay when said data signal passes through said FF portion and said amplifier 14.

14. An optical transmitter as set forth in claim 10, wherein when said intensity modulation is carried out using the CSRZ modulation scheme, said intensity modulation function unit is configured by a frequency division unit performing ½ frequency division of said second clock signal comprised of the clock component having the same rate as that of said data signal from said PLL portion, a delay unit giving a constant delay to the ½ frequency divided signal, and a second amplification unit amplifying the delay signal and outputting said second drive signal, the delay is set equal to the transmission delay when said data signal passes through said FF portion and said amplifier, and said second amplification unit outputs a voltage two times the extinction voltage of said intensity modulation.

15. An optical transmitter as set forth in claim 1, wherein said phase modulation function unit has an optical phase modulator, said intensity modulation function unit has an optical intensity modulator, the optical phase modulator is a DQPSK modulator or a DPSK modulator, and the optical intensity modulator is an RZ modulator or a CSRZ modulator.

16. A drive method of an optical transmitter having
a phase modulation function unit receiving as input a data signal to be transmitted to a receiver and modulating the phase of continuous wave light by a first drive signal generated in synchronization with a first clock signal and
an intensity modulation function unit further applying intensity modulation with respect to said phase modulated signal by a second drive signal generated in synchronization with a second clock signal, comprising:
a first step of dividing said data signal to be input to said phase modulation function unit at a stage in front of its input;
a second step of extracting a clock component from data signals divided according to said first step; and
a third step of generating said first clock signal and second clock signal from said clock component extracted according to said second step and inputting these to said phase modulation function unit and said intensity modulation function unit.
